(19) United States
(12) Patent Application Publication
(10) Pub. No.: US 2026/0019799 A1
(43) Pub. Date: Jan. 15, 2026

(54) MOBILE PLAN SIGNUP AND ACTIVATION IN ELECTRONIC DEVICE

(71) Applicant: Samsung Electronics Co., Ltd., Suwon-si (KR)

(72) Inventor: Rajeshkumar Somasekhar, Skillman, NJ (US)

(21) Appl. No.: 19/061,665

(22) Filed: Feb. 24, 2025

Related U.S. Application Data
(60) Provisional application No. 63/668,906, filed on Jul. 9, 2024.

(51) Int. Cl. H04W 8/20; H04W 8/18

(52) U.S. Cl. CPC H04W 8/20; H04W 8/183

(57) ABSTRACT

A method includes receiving input that includes a plan identifier from an electronic device. The plan identifier identifies a specified mobile plan for the electronic device. The method also includes, in response to receiving the input including the plan identifier, providing to the electronic device a prompt configured to launch an application on the electronic device. The method further includes automatically receiving, from the application, identifying information for the electronic device for use in implementing the specified mobile plan.

### CROSS-REFERENCE TO RELATED APPLICATION AND PRIORITY CLAIM

This application claims priority under 35 U.S.C. § 119(e) to U.S. Provisional Patent Application No. 63/668,906 filed on Jul. 9, 2024, which is hereby incorporated by reference in its entirety.

### TECHNICAL FIELD

This disclosure relates generally to communication systems and methods. More specifically, this disclosure relates to mobile plan signup and activation in an electronic device.

### BACKGROUND

Mobile electronic devices, such as smartphones and tablet computers, can typically receive a variety of services through one or more service providers. Many service providers use an embedded subscriber identity module (eSIM) to provide a mobile plan for a particular device. Thus, in order to sign up for and activate a new mobile plan, the user may need to download a new eSIM for the mobile plan to his or her device.

### SUMMARY

This disclosure relates to mobile plan signup and activation in an electronic device.

In a first embodiment, a method includes receiving input that includes a plan identifier from an electronic device. The plan identifier identifies a specified mobile plan for the electronic device. The method also includes, in response to receiving the input including the plan identifier, providing to the electronic device a prompt configured to launch an application on the electronic device. The method further includes automatically receiving, from the application, identifying information for the electronic device for use in implementing the specified mobile plan. In some cases, an electronic device may include at least one processing device configured to perform the method of the first embodiment. In other cases, a non-transitory machine-readable medium may include instructions that when executed cause at least one processor of an electric device to perform the method of the first embodiment.

Any single one or any combination of the following features may be used with the first embodiment. For each of a plurality of mobile plans, a corresponding deeplink can be provided on a web page of a service provider. The input including the plan identifier can be received in response to a user of the electronic device selecting the deeplink corresponding to the specified mobile plan. For each of a plurality of mobile plans, a corresponding optical code can be provided. The input including the plan identifier can be received in response to a user of the electronic device scanning the optical code corresponding to the specified mobile plan using the electronic device and selecting a link generated based on the scanning of the optical code. An embedded subscriber identity module (eSIM) can be downloaded onto the electronic device based on the identifying information. User information provided by a user of the electronic device can be received from the application. The user information can include at least one of login credentials, know-your-customer information, and billing information. The identifying information can include at least one of an international mobile equipment identifier (IMEI) and an embedded universal integrated circuit card identifier (EID) associated with the electronic device. The application can include a Global System for Mobile Communications Association (GSMA) TS.43 application programming interface (API).

In a second embodiment, a method includes providing input that includes a plan identifier from an electronic device to a service provider. The plan identifier identifies a specified mobile plan for the electronic device. The method also includes, in response to providing the input including the plan identifier, receiving at the electronic device a prompt from the service provider. The prompt is configured to launch an application on the electronic device. The method further includes automatically providing, from the application, identifying information for the electronic device to the service provider for use in implementing the specified mobile plan. In some cases, an electronic device may include at least one processing device configured to perform the method of the second embodiment.

Any single one or any combination of the following features may be used with the second embodiment. For each of a plurality of mobile plans, a corresponding deeplink can be provided on a web page of the service provider. The input including the plan identifier can be provided in response to a user of the electronic device selecting the deeplink corresponding to the specified mobile plan. For each of a plurality of mobile plans, a corresponding optical code can be provided on a marketing display of the service provider. The input including the plan identifier can be provided in response to a user of the electronic device scanning the optical code corresponding to the specified mobile plan using the electronic device and selecting a link generated based on the scanning of the optical code. In response to automatically providing the identifying information, an eSIM downloaded onto the electronic device by the service provider can be received. User information provided by a user of the electronic device can be provided to the service provider through the application. The user information can include at least one of login credentials, know-your-customer information, and billing information. The identifying information can include at least one of an IMEI and an EID associated with the electronic device. The application can include a GSMA TS.43 API.

In a third embodiment, a non-transitory machine-readable medium contains instructions that when executed cause at least one processor of an electronic device to provide input that includes a plan identifier from the electronic device to a service provider. The plan identifier identifies a specified mobile plan for the electronic device. The non-transitory machine-readable medium also contains instructions that when executed cause the at least one processor, in response to providing the input comprising the plan identifier, to receive at the electronic device a prompt from the service provider. The prompt is configured to launch an application on the electronic device. The non-transitory machine-readable medium further contains instructions that when executed cause the at least one processor to automatically provide, from the application, identifying information for the electronic device to the service provider for use in implementing the specified mobile plan.

Any single one or any combination of the following features may be used with the third embodiment. For each of a plurality of mobile plans, a corresponding deeplink can be provided on a web page of the service provider. The input including the plan identifier can be provided in response to a user of the electronic device selecting the deeplink corresponding to the specified mobile plan. For each of a plurality of mobile plans, a corresponding optical code can be provided on a marketing display of the service provider. The input including the plan identifier can be provided in response to a user of the electronic device scanning the optical code corresponding to the specified mobile plan using the electronic device and selecting a link generated based on the scanning of the optical code. The non-transitory machine-readable can contain instructions that when executed cause the at least one processor, in response to automatically providing the identifying information, to receive an eSIM downloaded onto the electronic device by the service provider. The non-transitory machine-readable can contain instructions that when executed cause the at least one processor to provide, through the application, user information provided by a user of the electronic device to the service provider. The user information can include at least one of login credentials, know-your-customer information, and billing information. The identifying information can include at least one of an IMEI and an EID associated with the electronic device. The application can include a GSMA TS.43 API.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory, computer readable medium includes media where data can be permanently stored and media where data can be stored and later overwritten, such as a rewritable optical disc or an erasable memory device.

As used here, terms and phrases such as “have,” “may have,” “include,” or “may include” a feature (like a number, function, operation, or component such as a part) indicate the existence of the feature and do not exclude the existence of other features. Also, as used here, the phrases “A or B,” “at least one of A and/or B,” or “one or more of A and/or B” may include all possible combinations of A and B. For example, “A or B,” “at least one of A and B,” and “at least one of A or B” may indicate all of (1) including at least one A, (2) including at least one B, or (3) including at least one A and at least one B. Further, as used here, the terms “first” and “second” may modify various components regardless of importance and do not limit the components. These terms are only used to distinguish one component from another. For example, a first user device and a second user device may indicate different user devices from each other, regardless of the order or importance of the devices. A first component may be denoted a second component and vice versa without departing from the scope of this disclosure.

It will be understood that, when an element (such as a first element) is referred to as being (operatively or communicatively) “coupled with/to” or “connected with/to” another element (such as a second element), it can be coupled or connected with/to the other element directly or via a third element. In contrast, it will be understood that, when an element (such as a first element) is referred to as being “directly coupled with/to” or “directly connected with/to” another element (such as a second element), no other element (such as a third element) intervenes between the element and the other element.

As used here, the phrase “configured (or set) to” may be interchangeably used with the phrases “suitable for,” “having the capacity to,” “designed to,” “adapted to,” “made to,” or “capable of” depending on the circumstances. The phrase “configured (or set) to” does not essentially mean “specifically designed in hardware to.” Rather, the phrase “configured to” may mean that a device can perform an operation together with another device or parts. For example, the phrase “processor configured (or set) to perform A, B, and C” may mean a generic-purpose processor (such as a CPU or application processor) that may perform the operations by executing one or more software programs stored in a memory device or a dedicated processor (such as an embedded processor) for performing the operations.

The terms and phrases as used here are provided merely to describe some embodiments of this disclosure but not to limit the scope of other embodiments of this disclosure. It is to be understood that the singular forms “a,” “an,” and “the” include plural references unless the context clearly dictates otherwise. All terms and phrases, including technical and scientific terms and phrases, used here have the same meanings as commonly understood by one of ordinary skill in the art to which the embodiments of this disclosure belong. It will be further understood that terms and phrases, such as those defined in commonly-used dictionaries, should be interpreted as having a meaning that is consistent with their meaning in the context of the relevant art and will not be interpreted in an idealized or overly formal sense unless expressly so defined here. In some cases, the terms and phrases defined here may be interpreted to exclude embodiments of this disclosure.

Examples of an “electronic device” according to embodiments of this disclosure may include at least one of a smartphone, a tablet personal computer (PC), a mobile phone, a video phone, an e-book reader, a desktop PC, a laptop computer, a netbook computer, a workstation, a personal digital assistant (PDA), a portable multimedia player (PMP), an MP3 player, a mobile medical device, a camera, or a wearable device (such as smart glasses, a head-mounted device (HMD), electronic clothes, an electronic bracelet, an electronic necklace, an electronic accessory, an electronic tattoo, a smart mirror, or a smart watch). Other examples of an electronic device include a smart home appliance. Examples of the smart home appliance may include at least one of a television, a digital video disc (DVD) player, an audio player, a refrigerator, an air conditioner, a cleaner, an oven, a microwave oven, a washer, a dryer, an air cleaner, a set-top box, a home automation control panel, a security control panel, a TV box (such as SAMSUNG HOMESYNC, APPLETV, or GOOGLE TV), a smart speaker or speaker with an integrated digital assistant (such as SAMSUNG GALAXY HOME, APPLE HOMEPOD, or AMAZON ECHO), a gaming console (such as an XBOX, PLAYSTATION, or NINTENDO), an electronic dictionary, an electronic key, a camcorder, or an electronic picture frame. Still other examples of an electronic device include at least one of various medical devices (such as diverse portable medical measuring devices (like a blood sugar measuring device, a heartbeat measuring device, or a body temperature measuring device), a magnetic resource angiography (MRA) device, a magnetic resource imaging (MRI) device, a computed tomography (CT) device, an imaging device, or an ultrasonic device), a navigation device, a global positioning system (GPS) receiver, an event data recorder (EDR), a flight data recorder (FDR), an automotive infotainment device, a sailing electronic device (such as a sailing navigation device or a gyro compass), avionics, security devices, vehicular head units, industrial or home robots, automatic teller machines (ATMs), point of sales (POS) devices, or Internet of Things (IoT) devices (such as a bulb, various sensors, electric or gas meter, sprinkler, fire alarm, thermostat, street light, toaster, fitness equipment, hot water tank, heater, or boiler). Other examples of an electronic device include at least one part of a piece of furniture or building/structure, an electronic board, an electronic signature receiving device, a projector, or various measurement devices (such as devices for measuring water, electricity, gas, or electromagnetic waves). Note that, according to various embodiments of this disclosure, an electronic device may be one or a combination of the above-listed devices. According to some embodiments of this disclosure, the electronic device may be a flexible electronic device. The electronic device disclosed here is not limited to the above-listed devices and may include new electronic devices depending on the development of technology.

In the following description, electronic devices are described with reference to the accompanying drawings, according to various embodiments of this disclosure. As used here, the term “user” may denote a human or another device (such as an artificial intelligent electronic device) using the electronic device.

Definitions for other certain words and phrases may be provided throughout this patent document. Those of ordinary skill in the art should understand that in many if not most instances, such definitions apply to prior as well as future uses of such defined words and phrases.

None of the description in this application should be read as implying that any particular element, step, or function is an essential element that must be included in the claim scope. The scope of patented subject matter is defined only by the claims. Moreover, none of the claims is intended to invoke 35 U.S.C. § 112(f) unless the exact words “means for” are followed by a participle. Use of any other term, including without limitation “mechanism,” “module,” “device,” “unit,” “component,” “element,” “member,” “apparatus,” “machine,” “system,” “processor,” or “controller,” within a claim is understood by the Applicant to refer to structures known to those skilled in the relevant art and is not intended to invoke 35 U.S.C. § 112(f).

### BRIEF DESCRIPTION OF THE DRAWINGS

For a more complete understanding of this disclosure and its advantages, reference is now made to the following description, taken in conjunction with the accompanying drawings, in which:

FIG. 1 illustrates an example of a network configuration including an electronic device in accordance with this disclosure;

FIG. 2 illustrates an example of a system supporting mobile plan signup and activation for electronic devices in accordance with this disclosure;

FIG. 3 illustrates an example of a technique for mobile plan signup and activation through a service provider website in accordance with this disclosure;

FIG. 4 illustrates an example of a technique for mobile plan signup and activation using an optical code in accordance with this disclosure;

FIG. 5 illustrates an example of a signaling diagram for providing mobile plan signup and activation for an electronic device in accordance with this disclosure;

FIG. 6 illustrates an example of a method for providing, in a mobile network operator, mobile plan signup and activation for an electronic device in accordance with this disclosure; and

FIG. 7 illustrates an example of a method for providing, in an electronic device, mobile plan signup and activation for the electronic device in accordance with this disclosure.

### DETAILED DESCRIPTION

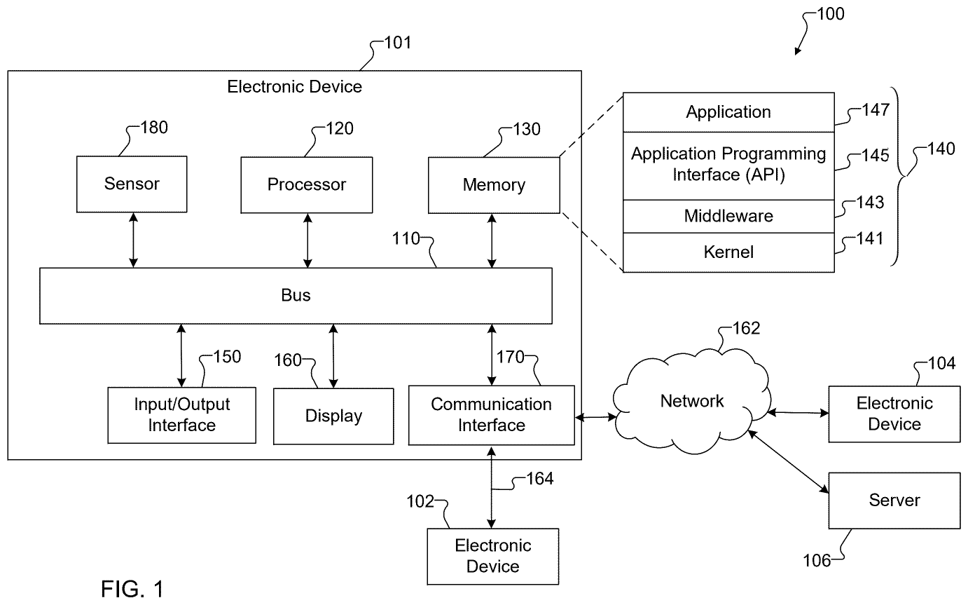

FIGS. 1 through 7, discussed below, and the various embodiments of this disclosure are described with reference to the accompanying drawings. However, it should be appreciated that this disclosure is not limited to these embodiments, and all changes and/or equivalents or replacements thereto also belong to the scope of this disclosure. The same or similar reference denotations may be used to refer to the same or similar elements throughout the specification and the drawings.

As noted above, mobile electronic devices, such as smartphones and tablet computers, can typically receive a variety of services through one or more service providers. Many service providers use an embedded subscriber identity module (eSIM) to provide a mobile plan for a particular device. Thus, in order to sign up for and activate a new mobile plan, the user may need to download a new eSIM for the mobile plan to his or her device.

Unfortunately, to download a new eSIM, a user is typically required to navigate through multiple steps, including manually entering device details needed to associate the new eSIM with the user's device. Among other things, the device details typically include an embedded universal integrated circuit card identifier (EID), which is usually a 32-digit number, and an international mobile equipment identifier (IMEI), which is usually 15 characters long. For the new mobile plan to be successfully activated, after first determining what the EID and IMEI are for his or her device, the user needs to manually enter the long strings of data without any errors for the service provider to be able to download the new eSIM to the correct device. Often times, a user is unaware of the EID and IMEI for the device, and data entry errors are common, making the current process a frustrating experience for the user. In addition, conventional techniques often require maintenance of a list of service providers in a user interface, which may force the user to go through each provider in the list, create an account for the provider, and check for offered plans. This approach is not user friendly, and onboarding new providers with this approach can require software or configuration updates to the user's device.

This disclosure provides various techniques for providing mobile plan signup and activation for electronic devices. As described in more detail below, a service provider can receive input that includes a plan identifier from an electronic device. The plan identifier identifies a specified mobile plan for the electronic device. In response to receiving the input that includes the plan identifier, the service provider can provide, to the electronic device, a prompt that is configured to launch an application on the electronic device. Identifying information for the electronic device for use in implementing the specified mobile plan can be automatically received from the application.

In this way, the disclosed techniques can be used to provide mobile plan signup and activation successfully without the need for a user to find an EID, an IMEI, or other device-identifying details and without relying on the user to manually enter the identifying details perfectly. Also, in some cases, service providers can simply embed a deeplink on their website or display an optical code for scanning, either of which can be used to launch a TS.43 client to complete a mobile plan purchase and activation on the user's device without requiring any onboarding overhead on devices. Thus, the user experience around mobile plan signup and activation can be greatly enhanced and provided more efficiently and accurately.

FIG. 1 illustrates an example of a network configuration 100 including an electronic device in accordance with this disclosure. The embodiment of the network configuration 100 shown in FIG. 1 is for illustration only. Other embodiments of the network configuration 100 could be used without departing from the scope of this disclosure.

According to embodiments of this disclosure, an electronic device 101 is included in the network configuration 100. The electronic device 101 can include at least one of a bus 110, a processor 120, a memory 130, an input/output (I/O) interface 150, a display 160, a communication interface 170, or a sensor 180. In some embodiments, the electronic device 101 may exclude at least one of these components or may add at least one other component. The bus 110 includes a circuit for connecting the components 120-180 with one another and for transferring communications (such as control messages and/or data) between the components.

The processor 120 includes one or more processing devices, such as one or more microprocessors, microcontrollers, digital signal processors (DSPs), application specific integrated circuits (ASICs), or field programmable gate arrays (FPGAs). In some embodiments, the processor 120 includes one or more of a central processing unit (CPU), an application processor (AP), a communication processor (CP), or a graphics processor unit (GPU). The processor 120 is able to perform control on at least one of the other components of the electronic device 101 and/or perform an operation or data processing relating to communication or other functions. As described below, the processor 120 may be used to provide mobile plan signup and activation for the electronic device 101 without requiring knowledge of identifying device details on the part of the user and without requiring error-free manual data entry by the user. In providing this functionality, the processor 120 may be used to execute an application that is configured to automatically provide the identifying device details to a service provider to facilitate downloading of an eSIM to the device 101 in order to activate a new mobile plan for the device 101.

The memory 130 can include a volatile and/or non-volatile memory. For example, the memory 130 can store commands or data related to at least one other component of the electronic device 101. According to embodiments of this disclosure, the memory 130 can store software and/or a program 140. The program 140 includes, for example, a kernel 141, middleware 143, an application programming interface (API) 145, and/or an application program (or “application”) 147. At least a portion of the kernel 141, middleware 143, or API 145 may be denoted an operating system (OS).

The kernel 141 can control or manage system resources (such as the bus 110, processor 120, or memory 130) used to perform operations or functions implemented in other programs (such as the middleware 143, API 145, or application 147). The kernel 141 provides an interface that allows the middleware 143, the API 145, or the application 147 to access the individual components of the electronic device 101 to control or manage the system resources. The application 147 may include one or more applications for performing mobile plan signup and activation for the electronic device 101. These functions can be performed by a single application or by multiple applications that each carries out one or more of these functions. The middleware 143 can function as a relay to allow the API 145 or the application 147 to communicate data with the kernel 141, for instance. A plurality of applications 147 can be provided. The middleware 143 is able to control work requests received from the applications 147, such as by allocating the priority of using the system resources of the electronic device 101 (like the bus 110, the processor 120, or the memory 130) to at least one of the plurality of applications 147. The API 145 is an interface allowing the application 147 to control functions provided from the kernel 141 or the middleware 143. For example, the API 145 includes at least one interface or function (such as a command) for filing control, window control, image processing, or text control.

The I/O interface 150 serves as an interface that can, for example, transfer commands or data input from a user or other external devices to other component(s) of the electronic device 101. The I/O interface 150 can also output commands or data received from other component(s) of the electronic device 101 to the user or the other external device.

The display 160 includes, for example, a liquid crystal display (LCD), a light emitting diode (LED) display, an organic light emitting diode (OLED) display, a quantum-dot light emitting diode (QLED) display, a microelectromechanical systems (MEMS) display, or an electronic paper display. The display 160 can also be a depth-aware display, such as a multi-focal display. The display 160 is able to display, for example, various contents (such as text, images, videos, icons, or symbols) to the user. The display 160 can include a touchscreen and may receive, for example, a touch, gesture, proximity, or hovering input using an electronic pen or a body portion of the user.

The communication interface 170, for example, is able to set up communication between the electronic device 101 and an external electronic device (such as a first electronic device 102, a second electronic device 104, or a server 106). For example, the communication interface 170 can be connected with a network 162 or 164 through wireless or wired communication to communicate with the external electronic device. The communication interface 170 can be a wired or wireless transceiver or any other component for transmitting and receiving signals, such as images.

The wireless communication is able to use at least one of, for example, WiFi, long term evolution (LTE), long term evolution-advanced (LTE-A), 5th generation wireless system (5G), millimeter-wave or 60 GHz wireless communication, Wireless USB, code division multiple access (CDMA), wideband code division multiple access (WCDMA), universal mobile telecommunication system (UMTS), wireless broadband (WiBro), or global system for mobile communication (GSM), as a communication protocol. The wired connection can include, for example, at least one of a universal serial bus (USB), high definition multimedia interface (HDMI), recommended standard 232 (RS-232), or plain old telephone service (POTS). The network 162 or 164 includes at least one communication network, such as a computer network (like a local area network (LAN) or wide area network (WAN)), Internet, or a telephone network.

The electronic device 101 further includes one or more sensors 180 that can meter a physical quantity or detect an activation state of the electronic device 101 and convert metered or detected information into an electrical signal. For example, one or more sensors 180 can include one or more cameras or other imaging sensors, which may be used to capture images of scenes. The sensor(s) 180 can also include one or more buttons for touch input, one or more microphones, a gesture sensor, a gyroscope or gyro sensor, an air pressure sensor, a magnetic sensor or magnetometer, an acceleration sensor or accelerometer, a grip sensor, a proximity sensor, a color sensor (such as an RGB sensor), a bio-physical sensor, a temperature sensor, a humidity sensor, an illumination sensor, an ultraviolet (UV) sensor, an electromyography (EMG) sensor, an electroencephalogram (EEG) sensor, an electrocardiogram (ECG) sensor, an infrared (IR) sensor, an ultrasound sensor, an iris sensor, or a fingerprint sensor. The sensor(s) 180 can further include an inertial measurement unit, which can include one or more accelerometers, gyroscopes, and other components. In addition, the sensor(s) 180 can include a control circuit for controlling at least one of the sensors included here. Any of these sensor(s) 180 can be located within the electronic device 101.

In some embodiments, the first external electronic device 102 or the second external electronic device 104 can be a wearable device or an electronic device-mountable wearable device (such as a head-mounted device (HMD)). When the electronic device 101 is mounted in the electronic device 102 (such as the HMD), the electronic device 101 can communicate with the electronic device 102 through the communication interface 170. The electronic device 101 can be directly connected with the electronic device 102 to communicate with the electronic device 102 without involving a separate network. The electronic device 101 can also be an augmented reality wearable device, such as eyeglasses, that include one or more imaging sensors.

The first and second external electronic devices 102 and 104 and the server 106 each can be a device of the same or a different type from the electronic device 101. According to certain embodiments of this disclosure, the server 106 includes a group of one or more servers. Also, according to certain embodiments of this disclosure, all or some of the operations executed on the electronic device 101 can be executed on another or multiple other electronic devices (such as the electronic devices 102 and 104 or server 106). Further, according to certain embodiments of this disclosure, when the electronic device 101 should perform some function or service automatically or at a request, the electronic device 101, instead of executing the function or service on its own or additionally, can request another device (such as electronic devices 102 and 104 or server 106) to perform at least some functions associated therewith. The other electronic device (such as electronic devices 102 and 104 or server 106) is able to execute the requested functions or additional functions and transfer a result of the execution to the electronic device 101. The electronic device 101 can provide a requested function or service by processing the received result as it is or additionally. To that end, a cloud computing, distributed computing, or client-server computing technique may be used, for example. While FIG. 1 shows that the electronic device 101 includes the communication interface 170 to communicate with the external electronic device 104 or server 106 via the network 162 or 164, the electronic device 101 may be independently operated without a separate communication function according to some embodiments of this disclosure.

The server 106 can include the same or similar components 110-180 as the electronic device 101 (or a suitable subset thereof). The server 106 can support to drive the electronic device 101 by performing at least one of operations (or functions) implemented on the electronic device 101. For example, the server 106 can include a processing module or processor that may support the processor 120 implemented in the electronic device 101. As described below, the server 106 may be used to support mobile plan signup and activation for the electronic device 101. In providing this functionality, the server 106 may be used to receive information from an application executed on the electronic device 101 that is configured to automatically provide the identifying device details to the server 106 to facilitate downloading of an eSIM to the device 101 in order to activate a new mobile plan for the device 101.

Although FIG. 1 illustrates one example of a network configuration 100 including an electronic device 101, various changes may be made to FIG. 1. For example, the network configuration 100 could include any number of each component in any suitable arrangement. In general, computing and communication systems come in a wide variety of configurations, and FIG. 1 does not limit the scope of this disclosure to any particular configuration. Also, while FIG. 1 illustrates one operational environment in which various features disclosed in this patent document can be used, these features could be used in any other suitable system.

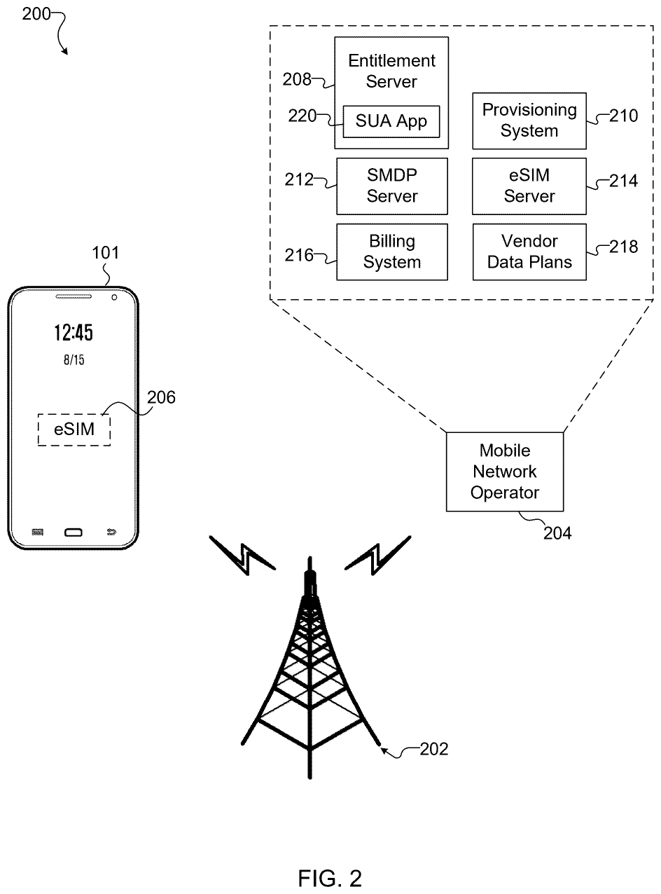

FIG. 2 illustrates an example of a system 200 supporting mobile plan signup and activation for electronic devices in accordance with this disclosure. For ease of explanation, the system 200 shown in FIG. 2 is described as being implemented on or supported by the electronic device 101 and the server 106 in the network configuration 100 of FIG. 1. However, the system 200 shown in FIG. 2 could be used with any other suitable electronic device(s) and in any other suitable system(s).

As shown in FIG. 2, the system 200 includes the electronic device 101, one or more base stations 202, and at least one mobile network operator (MNO) 204 (which may operate or otherwise be associated with one or more servers 106). The electronic device 101 is configured to communicate through the base station(s) 202 with at least one MNO 204 and to receive service from the at least one MNO 204. Depending on the circumstances, the electronic device 101 may receive service from one MNO 204 or from multiple MNOs 204. According to embodiments of this disclosure, the electronic device 101 is configured to use at least one eSIM 206, each of which may be independently configured to attach to a particular MNO 204. For example, if the electronic device 101 includes three eSIMs 206, the eSIMs 206 may be configured to attach to three different MNOs 204, such as in order to receive service from the different MNOs 204. Note that while the base station 202 is shown here as being separate from the MNO 204, base stations 202 are often said to represent a radio access network (RAN) of each MNO 204.

Each MNO 204 generally includes various components used to provide services to the electronic device 101 and other devices. For example, each MNO 204 may include a Global System for Mobile Communications Association (GSMA) TS.43 application programming interface (API)-based entitlement server 208 that can receive requests from and provide responses to the electronic device 101 and other devices. In some embodiments, as described in more detail below, the entitlement server 208 can include a signup-and-activation application (SUA app) 220 for providing mobile plan signup and activation in the electronic device 101. Each MNO 204 may include a provisioning system 210 that can be used to provision eSIMs 206 for the electronic device 101 and other devices, and each MNO 204 may include a subscription manager data preparation (SMDP) server 212 that is used to process information from the provisioning system 210 to generate personalized eSIMs 206 for the electronic device 101 and other devices. The personalized eSIMs 206 may be stored and provided to the electronic device 101 and other devices using an eSIM server 214 of the corresponding MNO 204. Each MNO 204 typically includes a billing system 216 that can be used to invoice customers of the MNO 204. Each MNO 204 may include a vendor data plans server 218 that allows vendors or other third-parties to offer pre-paid services or other services through the MNO 204. In some cases, each one of these components may be implemented using one or more servers, such as one or more servers 106.

Although FIG. 2 illustrates one example of a system 200 for supporting mobile plan signup and activation for electronic devices, various changes may be made to FIG. 2. For example, the system 200 of FIG. 2 has been simplified for ease of illustration and explanation and may include a much larger number of components, possibly spread over a wide geographic area.

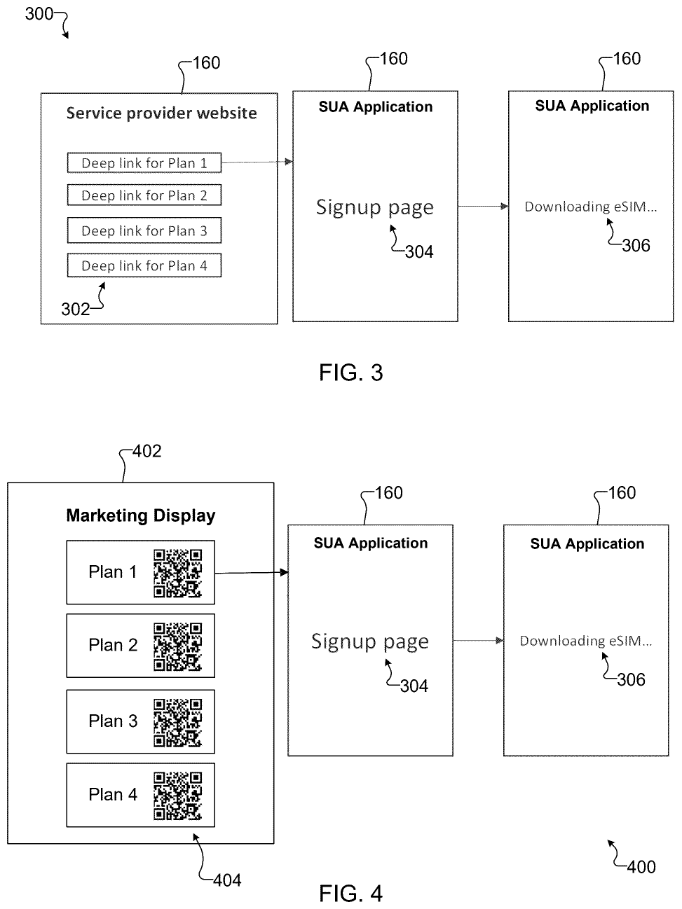

FIG. 3 illustrates an example of a technique 300 for mobile plan signup and activation through a service provider website in accordance with this disclosure. For ease of explanation, the technique 300 shown in FIG. 3 is described as being used in conjunction with the electronic device 101 of FIGS. 1 and 2. However, the technique 300 shown in FIG. 3 could be used with any other suitable electronic device(s) and in any other suitable system(s).

As shown in FIG. 3, using an Internet browser installed on the electronic device 101, a user may navigate to a service provider website that can be presented on the display 160 of the electronic device 101. The display 160 can present a list of options in the form of deeplinks 302, such as one or more options associated with one or more mobile plans offered by the MNO 204 that are not currently part of the service plan associated with the electronic device 101. If the user selects one of the options by selecting the corresponding deeplink 302, the electronic device 101 can launch the SUA application 220, which can present a signup page 304 for the selected mobile plan on the display 160.

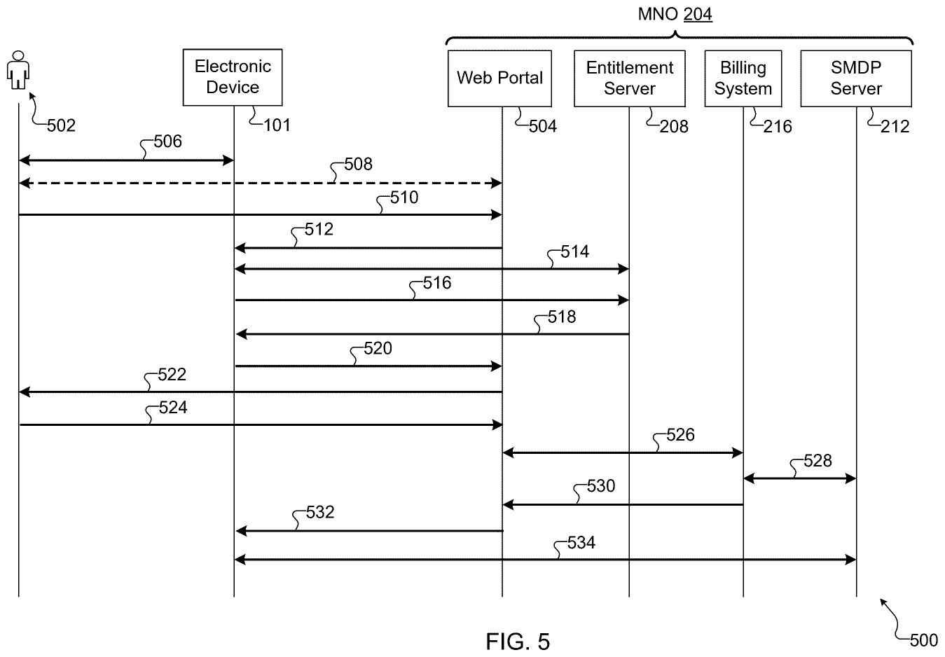

As described in more detail below in connection with FIGS. 5 through 7, the SUA application 220 can interact with the MNO 204 and automatically provide identifying information for the electronic device 101. After user information, such as login credentials, know-your-customer information, billing information and/or the like, is provided by the user of the electronic device 101 to the MNO 204 through the signup page 304, the SUA application 220 can initiate downloading of an eSIM 206 for the selected mobile plan. The SUA application 220 can present a download message 306 on the display 160 for the user indicating that the eSIM 206 is being downloaded to the electronic device 101.

In some cases, requests and responses during this process can comply with the GSMA TS.43 API specification. Also, in some cases, each of the deeplinks 302 can have a format of ODSA: “TS43 FQDN”$“MobilePlanID”. Here, “ODSA” refers to a TS.43-compliant On Device Service Activation client, “TS43 FQDN” represents a uniform resource locator (URL) for the entitlement server 208 implementing GSMA-defined TS.43 APIs for ODSA hosted by a service provider, and “MobilePlanID” represents the plan identifier for the mobile plan selected by the user.

This approach allows an end user's electronic device 101 to automatically provide the identifying information for the electronic device 101 in order to set up a mobile plan without requiring the user to determine and manually enter the identifying information. This can simplify the process of setting up a new mobile plan, as well as eliminate the risk of receiving inaccurate identifying information at the MNO 204 due to user error in inputting the information.

Although FIG. 3 illustrates one example of a technique 300 for mobile plan signup and activation through a service provider website, various changes may be made to FIG. 3. For example, the technique 300 of FIG. 3 has been simplified for ease of illustration and explanation. In some cases, for instance, there may be a number of messages exchanged between the electronic device 101 and the MNO 204 to perform mobile plan signup and activation.

FIG. 4 illustrates an example of a technique 400 for mobile plan signup and activation using an optical code in accordance with this disclosure. For ease of explanation, the technique 400 shown in FIG. 4 is described as being used in conjunction with the electronic device 101 of FIGS. 1 and 2. However, the technique 400 shown in FIG. 4 could be used with any other suitable electronic device(s) and in any other suitable system(s).

As shown in FIG. 4, a marketing display 402 can be presented to a user of an electronic device 101. In some cases, the marketing display 402 can be provided in the form of a poster or other type of physical or electronic display provided on a wall, a countertop, a window, or other suitable display surface in a service provider's physical store, in an electronics store that provides marketing space to the service provider, or in any other suitable location. The marketing display 402 can present a list of options in the form of optical codes 404, such as one or more options associated with one or more mobile plans offered by the MNO 204 that are not currently part of the service plan associated with the electronic device 101. In some embodiments, the optical codes 404 can include quick-response (QR) codes or any other suitable type of optical codes. If the user selects one of the options by scanning the corresponding optical code 404 using the electronic device 101 and selecting a resulting link provided on the display 160 of the electronic device 101, the electronic device 101 can launch the SUA application 220, which can present a signup page 304 for the selected mobile plan on the display 160 of the electronic device 101.

As described in more detail below in connection with FIGS. 5 through 7, the SUA application 220 can interact with the MNO 204 and automatically provide identifying information for the electronic device 101. After user information, such as login credentials, know-your-customer information, billing information and/or the like, is provided by the user of the electronic device 101 to the MNO 204 through the signup page 304, the SUA application 220 can initiate downloading of an eSIM 206 for the selected mobile plan. The SUA application 220 can present a download message 306 on the display 160 for the user indicating that the eSIM 206 is being downloaded to the electronic device 101.

In some cases, requests and responses during this process can comply with the GSMA TS.43 API specification. Also, in some cases, each of the links generated by scanning an optical code 404 can have a format of ODSA: “TS43 FQDN”$“MobilePlanID”. This approach allows an end user's electronic device 101 to automatically provide the identifying information for the electronic device 101 in order to set up a mobile plan without requiring the user to determine and manually enter the identifying information. This can simplify the process of setting up a new mobile plan, as well as eliminate the risk of receiving inaccurate identifying information at the MNO 204 due to user error in inputting the information.

Although FIG. 4 illustrates one example of a technique 400 for mobile plan signup and activation using an optical code 404, various changes may be made to FIG. 4. For example, the technique 400 of FIG. 4 has been simplified for ease of illustration and explanation. In some cases, for instance, there may be a number of messages exchanged between the electronic device 101 and the MNO 204 to perform mobile plan signup and activation.

FIG. 5 illustrates an example of a signaling diagram 500 for providing mobile plan signup and activation for an electronic device 101 in accordance with this disclosure. For ease of explanation, the signaling diagram 500 shown in FIG. 5 is described as being used in conjunction with the electronic device 101 of FIGS. 1 and 2. However, the signaling diagram 500 shown in FIG. 5 could be used with any other suitable electronic device(s) and in any other suitable system(s).

As shown in FIG. 5, a process flow illustrated by the signaling diagram 500 involves an electronic device 101, a user 502 of the electronic device 101, and various components of an MNO 204. In some embodiments, the user 502 can initiate the process flow in an operation 506 by using the electronic device 101 to launch a browser to access a web portal 504 of the MNO 204, followed by searching the web portal 504 for available mobile plans in the region in an optional operation 508 as described below. In other embodiments, the user 502 can initiate the process flow in the operation 506 by scanning an optical code 404 for a selected mobile plan. For these embodiments, the user 502 can receive details regarding available mobile plans in the region through marketing literature, employee assistance, or in any other suitable manner before making the selection of a mobile plan and scanning the corresponding optical code 404.

In embodiments in which the user 502 launches a browser in the operation 506, the user 502 can review details related to mobile plans available in the region through information provided by the web portal 504 in the optional operation 508 before making a selection of a mobile plan. In embodiments in which the user 502 initiates the process flow in the operation 506 by scanning an optical code 404 for a selected mobile plan, the optional operation 508 may be omitted. In embodiments in which the user 502 receives details regarding available mobile plans in the region in optional operation 508, the user 502 can select a mobile plan by clicking on a deeplink 302 corresponding to that mobile plan on the display 160 of the electronic device 101, resulting in a request 510 being sent to the web portal 504 to signup for the selected mobile plan. In embodiments in which the user 502 initiates the process flow in the operation 506 by scanning an optical code 404 for a selected mobile plan, the user can select the link generated by the scanning of the optical code 404 on the display 160, resulting in the request 510 being sent to the web portal 504 to sign up for the selected mobile plan. For embodiments of either type, the request 510 can include a plan identifier that identifies the selected mobile plan.

A response 512 from the web portal 504 to the electronic device 101 can prompt the electronic device 101 to launch the SUA application 220 from the entitlement server 208 on the electronic device 101. In some cases, the response 512 can include a fully qualified domain name (FQDN) for the entitlement server 208 and the plan identifier. The electronic device 101 and the entitlement server 208 can interact to provide authentication 514 of the electronic device 101 for the entitlement server 208. This may include, for example, providing an access token to the electronic device 101 to allow access to the entitlement server 208.

After authentication 514, the electronic device 101 can provide a request 516 to the entitlement server 208 that includes identifying information for the electronic device 101. The request 516 may include, for example, an IMEI, an EID, and/or any other information suitable for identifying the electronic device 101. The request 516 can also include the access token and the plan identifier. The entitlement server 208 can provide a response 518 to the electronic device 101 that includes service-related information, such as a URL associated with the selected mobile plan and user data associated with the selected mobile plan.

The electronic device 101 can provide a message 520 to the web portal 504 that includes the user data and the plan identifier. The web portal 504 can provide a request 522 to the user 502 through the display 160 of the electronic device 101. The request 522 can be provided to the user 502 by the SUA application 220 through the sign-up page 304. The user 502 can provide a response 524 to the web portal 504 through the electronic device 101 by providing the requested user information through the sign-up page 304. The user information may include, for example, login credentials, know-your-customer information, billing information and/or the like.

In response to receiving the user information through the response 524, the web portal 504 can interact with the billing system 216 to complete a provisioning request 526. The provisioning request 526 may include, for example, the user information, the IMEI, and the EID. Based on the provisioning request 526, the billing system 216 and the SMDP server 212 can interact to release 528 an eSIM 206 for the electronic device 101 based on the EID provided in the provisioning request 526. Based on the release 528 of the eSIM 206, the billing system 216 can provide a provisioning success message 530 to the web portal 504 that includes the SMDP URL and an integrated circuit card identification (ICCID) for the electronic device 101.

In response to receiving the provisioning success message 530, the web portal 504 can send a message 532 to the electronic device 101 that includes the SMDP URL and the ICCID. The message 532 can include a JavaScript callback message. The electronic device 101 and the SMDP server 212 can interact to complete a profile download 534 for the eSIM 206. While the profile download 534 is being completed, the SUA application 220 can present a download message 306 for the user 502 on the display 160 of the electronic device 101 indicating that the eSIM 206 is being downloaded to the electronic device 101.

In this way, the electronic device 101 and the MNO 204 may provide mobile plan signup and activation successfully without the need for the user 502 to find an EID, an IMEI, or other device-identifying details and without relying on the user 502 to manually enter the identifying details perfectly. In addition, the MNO 204 can simply embed a deeplink 302 on their web portal 504 or display an optical code 404 for scanning, either of which can be used to launch the SUA application 220 to complete a mobile plan purchase and activation on the user's electronic device 101 without requiring any onboarding overhead on the electronic device 101. Thus, the user experience around mobile plan signup and activation can be greatly enhanced and provided more efficiently and accurately.

Although FIG. 5 illustrates one example of a signaling diagram 500 for providing mobile plan signup and activation for an electronic device 101, various changes may be made to FIG. 5. For example, while FIG. 5 illustrates various signaling between components, any desired subset of the signaling may be used, or other or additional signaling may be used. As a particular example, the specific messages exchanged during the signaling can vary depending on the type of network supported by the MNO 204.

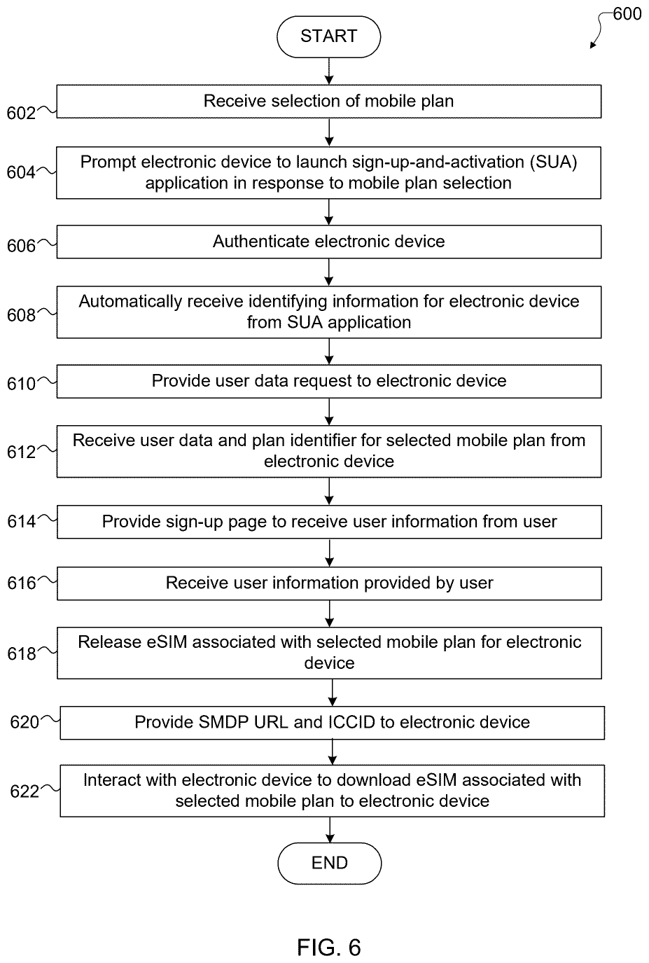

FIG. 6 illustrates an example of a method 600 for providing, in an MNO 204, mobile plan signup and activation for an electronic device 101 in accordance with this disclosure. For ease of explanation, the method 600 shown in FIG. 6 is described as being used in conjunction with the electronic device 101 and MNO 204 of FIGS. 1 and 2. However, the method 600 shown in FIG. 6 could be used with any other suitable electronic device(s) and in any other suitable system(s).

As shown in FIG. 6, the MNO 204 receives a selection of a mobile plan at step 602. The selection may include, for example, a plan identifier corresponding to the selected mobile plan. In some cases, this may include the user 502 of the electronic device 101 launching a browser to access a web portal 504 of the MNO 204, searching the web portal 504 for available mobile plans in the region, and making a selection by clicking on a deeplink 302 associated with the selected mobile plan on the display 160 of the electronic device 101. The MNO 204 can receive the mobile plan selection based on the user 502 clicking on the deeplink 302. In other cases, this step may include the user 502 scanning an optical code 404 for a selected mobile plan and clicking on a link associated with the selected mobile plan that is generated on the display 160 of the electronic device 101 by the scanning of the optical code 404. The MNO 204 can receive the mobile plan selection based on the clicking of the user 502 on the link generated by the scanning of the optical code 404.

The MNO 204 prompts the electronic device 101 to launch the SUA application 220 in response to receiving the mobile plan selection at step 604. This may include, for example, the MNO 204 prompting the processor 120 of the electronic device 101 to launch the SUA application 220 on the electronic device 101. The prompt can include the plan identifier and an FQDN for the entitlement server 208, which can include the SUA application 220. The MNO 204 authenticates the electronic device 101 at step 606. This may include, for example, the electronic device 101 and the entitlement server 208 interacting to provide authentication of the electronic device 101 for the entitlement server 208. As particular examples, this may include the MNO 204 providing an access token to the electronic device 101 to allow access to the entitlement server 208.

The MNO 204 automatically receives identifying information for the electronic device 101 from the SUA application 220 at step 608. This may include, for example, receiving the identifying information automatically from the SUA application 220 being executed by the processor of the electronic device 101. In some cases, the identifying information for the electronic device 101 can include an IMEI, an EID, and/or any other suitable identifying information. This may also include the MNO 204 automatically receiving the access token and the plan identifier from the SUA application 220.

The MNO 204 provides a user data request to the electronic device 101 at step 610. This may include, for example, the entitlement server 208 providing service-related information, such as a URL associated with the selected mobile plan and desired user data for the selected mobile plan, to the electronic device 101. The MNO 204 receives user data and the plan identifier for the selected mobile plan from the electronic device 101 at step 612. This may include, for example, the MNO 204 receiving a message that includes the user data and the plan identifier from the SUA application 220 operating on the electronic device 101.

The MNO 204 provides a sign-up page 304 through the SUA application 220 to receive user information from the user 502 at step 614. This may include, for example, the web portal 504 providing the sign-up page 304 for presentation by the SUA application 220 to the user 502 through the display 160 of the electronic device 101. The MNO 204 receives the user information provided by the user 502 at step 616. This may include, for example, the MNO 204 receiving user information provided by the user 502 through the sign-up page 304 presented on the display 160 on the electronic device 101 by the SUA application 220 at the web portal 504. In some cases, the user information may include login credentials, know-your-customer information, billing information and/or the like.

The MNO 204 releases an eSIM 206 associated with the selected mobile plan for the electronic device 101 at step 618. This may include, for example, the web portal 504 interacting with the billing system 216 to complete a provisioning request. In some cases, the provisioning request may include the user information, the IMEI, and the EID. Based on the provisioning request, the billing system 216 and the SMDP server 212 can interact to release the eSIM 206 for the electronic device 101 based on the EID provided in the provisioning request. In addition, based on the release of the eSIM 206, the billing system 216 can provide a provisioning success message to the web portal 504 that includes the SMDP URL and the ICCID for the electronic device 101.

The MNO 204 provides an SMDP URL and an ICCID to the electronic device 101 at step 620. This may include, for example, the web portal 504 sending a message to the electronic device 101 that includes the SMDP URL and the ICCID. In some cases, the message can include a JavaScript callback message. The MNO 204 interacts with the electronic device 101 to download the eSIM 206 associated with the selected mobile plan to the electronic device 101 at step 622. This may include, for example, the SMDP server 212 and the electronic device 101 interacting to complete a profile download for the eSIM 206. In some cases, while the profile download is being completed, the SUA application 220 can present a download message 306 for the user 502 on the display 160 of the electronic device 101 indicating that the eSIM 206 is being downloaded to the electronic device 101. Once the download of the eSIM 206 is finished, the sign-up and activation of the selected mobile plan is complete.

In this way, the method 600 provides for the MNO 204 to facilitate mobile plan signup and activation successfully without the need for the user 502 to find an EID, an IMEI, or other device-identifying details and without relying on the user 502 to manually enter the identifying details perfectly. In addition, the MNO 204 can simply embed a deeplink 302 on their web portal 504 or display an optical code 404 for scanning, either of which can be used to launch the SUA application 220 to complete a mobile plan purchase and activation on the user's electronic device 101 without requiring any onboarding overhead on the electronic device 101. Thus, the user experience around mobile plan signup and activation can be greatly enhanced and provided more efficiently and accurately.

Although FIG. 6 illustrates one example of a method 600 for providing, in an MNO 204, mobile plan signup and activation for an electronic device 101 in accordance with this disclosure, various changes may be made to FIG. 6. For example, while shown as a series of steps, various steps in FIG. 6 may overlap, occur in parallel, occur in a different order, or occur any number of times (including zero times).

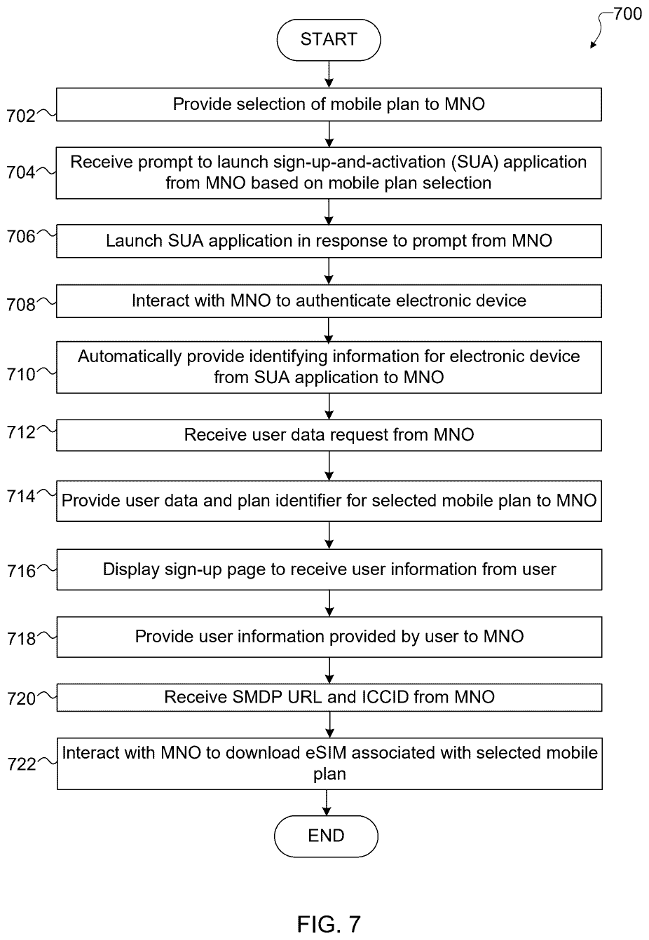

FIG. 7 illustrates an example of a method 700 for providing, in an electronic device 101, mobile plan signup and activation for the electronic device 101 in accordance with this disclosure. For ease of explanation, the method 700 shown in FIG. 7 is described as being used in conjunction with the electronic device 101 and MNO 204 of FIGS. 1 and 2. However, the method 700 shown in FIG. 7 could be used with any other suitable electronic device(s) and in any other suitable system(s).

As shown in FIG. 7, the electronic device 101 provides a selection of a mobile plan to an MNO 204 at step 702. The selection may include, for example, a plan identifier corresponding to the selected mobile plan. In some cases, this may include the user 502 of the electronic device 101 launching a browser to access a web portal 504 of the MNO 204, searching the web portal 504 for available mobile plans in the region, and making a selection by clicking on a deeplink 302 associated with the selected mobile plan on the display 160 of the electronic device 101. The electronic device 101 can provide the mobile plan selection based on the clicking of the user 502 on the deeplink 302. In other cases, this may include the user 502 scanning an optical code 404 for a selected mobile plan and clicking on a link associated with the selected mobile plan that is generated on the display 160 of the electronic device 101 by the scanning of the optical code 404. The electronic device 101 can provide the mobile plan selection based on the clicking of the user 502 on the link generated by the scanning of the optical code 404.

The electronic device 101 receives a prompt from the MNO 204 to launch the SUA application 220 based on the mobile plan selection being provided to the MNO 204 at step 704. This may include, for example, the electronic device 101 receiving a prompt to launch the SUA application 220 at the processor 120 of the electronic device 101. The prompt can include the plan identifier and an FQDN for the entitlement server 208, which can include the SUA application 220. The electronic device 101 launches the SAU application 220 in response to the prompt received from the MNO 204 at step 706.

The electronic device 101 interacts with the MNO 204 to authenticate the electronic device 101 at step 708. This may include, for example, the electronic device 101 and the entitlement server 208 interacting to provide authentication of the electronic device 101 for the entitlement server 208. As particular examples, this may include the electronic device 101 receiving an access token from the MNO 204 to allow access to the entitlement server 208 for the electronic device 110.

The electronic device 101 automatically provides identifying information for the electronic device 101 from the SUA application 220 to the MNO 204 at step 710. This may include, for example, the electronic device 101 providing the identifying information automatically from the SUA application 220 being executed by the processor 120 of the electronic device 101. In some cases, the identifying information for the electronic device 101 can include an IMEI, an EID, and/or any other suitable identifying information. This may also include the electronic device 101 automatically providing the access token and the plan identifier from the SUA application 220 to the MNO 204.

The electronic device 101 receives a user data request from the MNO 204 at step 712. This may include, for example, the electronic device 101 receiving service-related information, such as a URL associated with the selected mobile plan and desired user data for the selected mobile plan, from the entitlement server 208. The electronic device 101 provides user data and a plan identifier for the selected mobile plan to the MNO 204 at step 714. This may include, for example, the electronic device 101 providing a message that includes the user data and the plan identifier from the SUA application 220 operating on the electronic device 101 to the MNO 204.

The electronic device 101 displays a sign-up page 304 to receive user information from the user 502 at step 716. This may include, for example, the web portal 504 providing the sign-up page 304 to the user 502 through the SUA application 220. The sign-up page 304 can be presented on the display 160 of the electronic device 101. The electronic device 101 provides the user information provided by the user 502 to the MNO 204 at step 718. This may include, for example, the electronic device 101 providing user information from the user 502 to the web portal 504. The user 502 can provide the user information through the sign-up page 304 presented on the display 160 of the electronic device 101 by the SUA application 220. In some cases, the user information may include login credentials, know-your-customer information, billing information and/or the like.

The electronic device 101 receives an SMDP URL and an ICCID from the MNO 204 at step 720. This may include, for example, the web portal 504 sending a message to the electronic device 101 that includes the SMDP URL and the ICCID. In some cases, the message can include a JavaScript callback message. In addition, the web portal 504 can send the message including the SMDP URL and the ICCID after the MNO 204 releases an eSIM 206 associated with the selected mobile plan for the electronic device 101.

The electronic device 101 interacts with the MNO 204 to download the eSIM 206 associated with the selected mobile plan to the electronic device 101 at step 722. This may include, for example, the electronic device 101 and the SMDP server 212 interacting to complete a profile download for the eSIM 206. In some cases, while the profile download is being completed, the SUA application 220 can present a download message 306 on the display 160 of the electronic device 101 for the user 502 indicating that the eSIM 206 is being downloaded to the electronic device 101. Once the download of the eSIM 206 is finished, the signup and activation of the selected mobile plan is complete.

In this way, the method 700 provides for the electronic device 101 to facilitate mobile plan signup and activation successfully without the need for the user 502 to find an EID, an IMEI, or other device-identifying details and without relying on the user 502 to manually enter the identifying details perfectly. In addition, the MNO 204 can simply embed a deeplink 302 on their web portal 504 or display an optical code 404 for scanning, either of which can be used to launch the SUA application 220 to complete a mobile plan purchase and activation on the user's electronic device 101 without requiring any onboarding overhead on the electronic device 101. Thus, the user experience around mobile plan signup and activation can be greatly enhanced and provided more efficiently and accurately.

Although FIG. 7 illustrates one example of a method 700 for providing, in an electronic device 101, mobile plan signup and activation for the electronic device 101 in accordance with this disclosure, various changes may be made to FIG. 7. For example, while shown as a series of steps, various steps in FIG. 7 may overlap, occur in parallel, occur in a different order, or occur any number of times (including zero times).

It should be noted that the functions shown in or described with respect to FIGS. 2 through 7 can be implemented in an electronic device 101 or other device in any suitable manner. For example, in some embodiments, at least some of the functions shown in or described with respect to FIGS. 2 through 7 can be implemented or supported using one or more software applications or other software instructions that are executed by the processor 120 of the electronic device 101 or other device. In other embodiments, at least some of the functions shown in or described with respect to FIGS. 2 through 7 can be implemented or supported using dedicated hardware components. In general, the functions shown in or described with respect to FIGS. 2 through 7 can be performed using any suitable hardware or any suitable combination of hardware and software/firmware instructions.

Although this disclosure has been described with reference to various example embodiments, various changes and modifications may be suggested to one skilled in the art. It is intended that this disclosure encompass such changes and modifications as fall within the scope of the appended claims.

What is claimed is:

1. A method comprising:
receiving input comprising a plan identifier from an electronic device, wherein the plan identifier identifies a specified mobile plan for the electronic device;
in response to receiving the input comprising the plan identifier, providing to the electronic device a prompt configured to launch an application on the electronic device; and
automatically receiving, from the application, identifying information for the electronic device for use in implementing the specified mobile plan.

2. The method of claim 1, further comprising:
for each of a plurality of mobile plans, providing a corresponding deeplink on a web page of a service provider;
wherein the input comprising the plan identifier is received in response to a user of the electronic device selecting the deeplink corresponding to the specified mobile plan.

3. The method of claim 1, further comprising:
for each of a plurality of mobile plans, providing a corresponding optical code;
wherein the input comprising the plan identifier is received in response to a user of the electronic device scanning the optical code corresponding to the specified mobile plan using the electronic device and selecting a link generated based on the scanning of the optical code.

4. The method of claim 1, further comprising:
downloading an embedded subscriber identity module (eSIM) onto the electronic device based on the identifying information.

5. The method of claim 1, further comprising:
receiving, from the application, user information provided by a user of the electronic device;
wherein the user information comprises at least one of login credentials, know-your-customer information, and billing information.

6. The method of claim 1, wherein the identifying information comprises at least one of an international mobile equipment identifier (IMEI) and an embedded universal integrated circuit card identifier (EID) associated with the electronic device.

7. The method of claim 1, wherein the application comprises a Global System for Mobile Communications Association (GSMA) TS.43 application programming interface (API).

8. A method comprising:
providing input comprising a plan identifier from an electronic device to a service provider, wherein the plan identifier identifies a specified mobile plan for the electronic device;
in response to providing the input comprising the plan identifier, receiving at the electronic device a prompt from the service provider, wherein the prompt is configured to launch an application on the electronic device; and
automatically providing, from the application, identifying information for the electronic device to the service provider for use in implementing the specified mobile plan.

9. The method of claim 8, wherein:
for each of a plurality of mobile plans, a corresponding deeplink is provided on a web page of the service provider; and
the input comprising the plan identifier is provided in response to a user of the electronic device selecting the deeplink corresponding to the specified mobile plan.

10. The method of claim 8, wherein:
for each of a plurality of mobile plans, a corresponding optical code is provided on a marketing display of the service provider; and
wherein the input comprising the plan identifier is provided in response to a user of the electronic device scanning the optical code corresponding to the specified mobile plan using the electronic device and selecting a link generated based on the scanning of the optical code.

11. The method of claim 8, further comprising:
in response to automatically providing the identifying information, receiving an embedded subscriber identity module (eSIM) downloaded onto the electronic device by the service provider.

12. The method of claim 8, further comprising:
providing, through the application, user information provided by a user of the electronic device to the service provider;
wherein the user information comprises at least one of login credentials, know-your-customer information, and billing information.

13. The method of claim 8, wherein the identifying information comprises at least one of an international mobile equipment identifier (IMEI) and an embedded universal integrated circuit card identifier (EID) associated with the electronic device.

14. The method of claim 8, wherein the application comprises a Global System for Mobile Communications Association (GSMA) TS.43 application programming interface (API).

15. A non-transitory machine-readable medium containing instructions that when executed cause at least one processor of an electronic device to:
provide input comprising a plan identifier from the electronic device to a service provider, wherein the plan identifier identifies a specified mobile plan for the electronic device;
in response to providing the input comprising the plan identifier, receive at the electronic device a prompt from the service provider, wherein the prompt is configured to launch an application on the electronic device; and
automatically provide, from the application, identifying information for the electronic device to the service provider for use in implementing the specified mobile plan.

16. The non-transitory machine-readable medium of claim 15, wherein:
for each of a plurality of mobile plans, a corresponding deeplink is provided on a web page of the service provider; and
the input comprising the plan identifier is provided in response to a user of the electronic device selecting the deeplink corresponding to the specified mobile plan.

17. The non-transitory machine-readable medium of claim 15, wherein:
for each of a plurality of mobile plans, a corresponding optical code is provided on a marketing display of the service provider; and
wherein the input comprising the plan identifier is provided in response to a user of the electronic device scanning the optical code corresponding to the specified mobile plan using the electronic device and selecting a link generated based on the scanning of the optical code.

18. The non-transitory machine-readable medium of claim 15, further containing instructions that when executed cause the at least one processor to:
in response to automatically providing the identifying information, receive an embedded subscriber identity module (eSIM) downloaded onto the electronic device by the service provider.

19. The non-transitory machine-readable medium of claim 15, further containing instructions that when executed cause the at least one processor to:
provide, through the application, user information provided by a user of the electronic device to the service provider;
wherein the user information comprises at least one of login credentials, know-your-customer information, and billing information.

20. The non-transitory machine-readable medium of claim 15, wherein at least one of:
the identifying information comprises at least one of an international mobile equipment identifier (IMEI) and an embedded universal integrated circuit card identifier (EID) associated with the electronic device; and
the application comprises a Global System for Mobile Communications Association (GSMA) TS.43 application programming interface (API).
